(19) United States
(12) Patent Application Publication
(10) Pub. No.: US 2003/0128864 A1
(43) Pub. Date: Jul. 10, 2003

(54) Method for weathering a sample and a weathering system

(76) Inventor: Bahman Sarabi, Krefeld (DE)

Correspondence Address: BAYER POLYMERS LLC, 100 BAYER ROAD, PITTSBURGH, PA, 15205, US

(21) Appl. No.: 10/271,909

(22) Filed: Oct. 16, 2002

(30) Foreign Application Priority Data
Oct. 22, 2001 (DE) 10152003.4

(51) Int. Cl. G06K 9/00

(52) U.S. Cl. 382/109; 382/100

(57) ABSTRACT

A method of weathering a sample over a period of time, and measuring color shifts of the sample is described. The method includes: (a) weathering the sample over a first interval of time; (b) determining the color coordinates of the sample after the first interval of time; and (c) repeating steps (a) and (b) for at least one successive interval of time until the completion of the period of time. In an embodiment of the present invention, step (b) further includes: (i) measuring the color coordinates of the sample after the first interval of time; (ii) providing access to at least one color master having color coordinates, the access being obtained by means of the color coordinates of the sample; and (iii) comparing the color master with the sample for verification of the color coordinates. Also described is a weathering system for weathering a sample over a period of time, that includes: (a) a means (100) for weathering the sample over a plurality of intervals of time of said period of time; (b) a means (102) for determining the color coordinates of the sample, in each case after an interval of time; and (c) (i) a means (103) for storing the color coordinates of the sample, determined by means (102), after each interval of time, and/or (ii) a means (104) for producing a color image of the sample, from the color coordinates of the sample determined by means (102), after each interval of time.

### CROSS REFERENCE TO RELATED PATENT APPLICATION

The present patent application claims the right of priority under 35 U.S.C. §119 (a)-(d) of German Patent Application No. 101 52 003.4-52, filed Oct. 22, 2001.

### FIELD OF THE INVENTION

The invention relates to a method for weathering a sample over a period of time, and to a weathering system.

### BACKGROUND OF THE INVENTION

Various weathering devices and methods are known from the prior art. For example, DE 42 36 897 A1, GM 89 06 975.7, DE 195 26 368 A1 and DE 42 36 897 provide various weathering apparatuses and methods for accelerated weathering of samples of materials.

Weathering tests are in general carried out to determine the change in a particular material over a period of time during which the material is exposed to particular environmental conditions. The course of the change in the material with respect to time during the period of time under observation is also typically of interest. Generally, such a period of time is divided into a plurality of part intervals and a sample or a sample batch is provided for each part interval.

After such a time interval has elapsed, the sample or sample batch assigned to the time interval is removed from the weathering apparatus and then evaluated and/or archived.

A relatively long weathering period which is divided into a plurality of time intervals, is generally associated with a corresponding expenditure of time, materials and money, in that an extra sample or sample batch must be provided for each time interval.

### SUMMARY OF THE INVENTION

The present invention is therefore based on the object of providing an improved method for weathering a sample over a period of time and an improved weathering system. The object on which the invention is based is achieved in each case with the features of the independent claims. Preferred embodiments of the invention are given in the dependent claims.

In accordance with the present invention, there is provided a method of weathering a sample (e.g., a single sample or a single batch of samples) over a period of time comprising:

(a) weathering the sample over an interval (e.g., a first interval) of time;

(b) determining the color coordinates of the sample after the first interval of time; and

(c) repeating steps (a) and (b) for at least one successive interval of time (e.g., a second, third, fourth, fifth, etc. interval of time) until the completion of said period of time.

The sum of all the internals of time are equal to the period of time. The period of time defines the total time that the sample is weathered (i.e., exposed to weathering conditions, e.g., artificial weathering conditions).

In accordance with the present invention, step (b) of the above recited method, further comprises:

(i) measuring the color coordinates of the sample after the first interval of time;

(ii) providing access to at least one color master having color coordinates, said access being obtained by means of the color coordinates of said sample; and

(iii) comparing the color master with the sample for verification of the color coordinates.

In accordance with the present invention, there is still further provided a weathering apparatus (or system) for weathering a sample over a period of time comprising:

(a) a means (100) for weathering the sample over a plurality of intervals of time of said period of time;

(b) a means (102) for determining the color coordinates of the sample, in each case after an interval of time; and

(c) at least one of,

(i) a means (103) for storing the color coordinates of the sample, determined by means (102), after each interval of time, and

(ii) a means (104) for producing a color image of the sample, from the color coordinates of the sample determined by means (102), after each interval of time.

Means (102) may be connected electronically (e.g., digitally) to means (103) and/or means (104).

The features that characterize the present invention are pointed out with particularity in the claims, which are annexed to and form a part of this disclosure. These and other features of the invention, its operating advantages and the specific objects obtained by its use will be more fully understood from the following detailed description and accompanying drawings in which preferred embodiments of the invention are illustrated and described.

Unless otherwise indicated, all numbers or expressions, such as those expressing structural dimensions, quantities of ingredients, etc. used in the specification and claims are understood as modified in all instances by the term “about.”

### BRIEF DESCRIPTION OF THE DRAWINGS

FIG. 1 is a representative block diagram of an embodiment of a weathering system according to the invention;

FIG. 2 is a representative flow chart (or algorithm) of an embodiment of a method according to the invention for weathering a sample over a period of time;

FIG. 3 is a representative outline block diagram of a system for determining the color coordinates of a sample, and for producing a color image of the sample;

FIG. 4 is a representative flow chart illustrating the production of a color catalogue;

FIG. 5 is a representative outline diagram of two different pages of a color catalogue;

FIG. 6 is a representative page of a color catalogue having holes in the central regions of each color master, the holes providing a means for visual comparison with a sample;

FIG. 7 is a representative flow chart of a first embodiment of a method according to the invention for determining color coordinates;

FIG. 8 is a representative flow chart of a second embodiment of the method according to the invention for determining color coordinates; and

FIG. 9 is a representative flow chart of an embodiment of a method according to the invention for producing a digital color image.

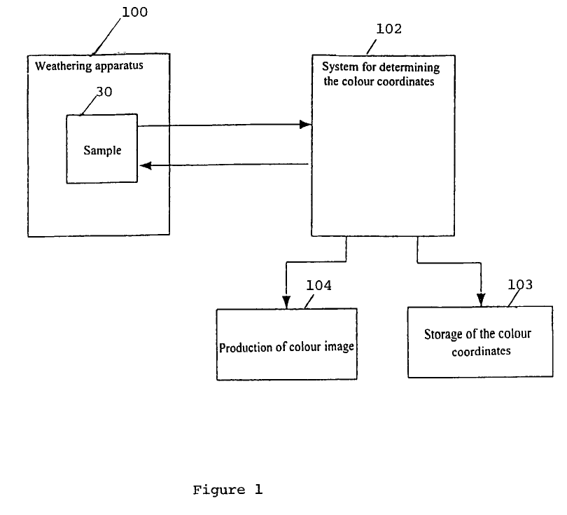

In FIGS. 1 through 9, like reference numerals designate the same components.

### DETAILED DESCRIPTION OF THE INVENTION

The invention allows a weathering experiment to be carried out over any desired period of time with only one sample or only one sample batch. For this, the sample or the sample batch is removed from the weathering apparatus after particular intervals of time. The color coordinates of a sample are then determined by means of a system for the determination of color coordinates. These color coordinates can then be stored for documentation purposes. Alternatively or in addition, a color image of the sample can be produced on the basis of these color coordinates. Thereafter, the sample or the sample batch is returned to the weathering unit in order to continue the weathering over the subsequent interval of time.

According to a preferred embodiment of the invention, a color catalogue system is used for the determination of the color coordinates of a sample. Such a color catalogue system is based on the use of color masters as the comparison standard for the exact determination of a color, that is to say the determination of the color coordinates of the color in a discrete color space. For this, a color space of interest is first divided into a number of discrete colors by means of a color coordinate system, and a color master is produced for each of the discrete colors.

Such a color master can be produced by means of a pictograph. A pictograph is an apparatus for producing a digital color image, which is generated on a special film by means of laser beams. Such pictographs are commercially obtainable e.g. from Fuji Photo Film Co., Ltd., Japan, in particular the apparatus Digital Image Printer Pictography 4000.

According to a preferred embodiment of the invention, the various color masters are combined in a catalogue. Such a catalogue has an index which corresponds to the particular color coordinates of the color masters, that is to say each of the color masters can be accessed directly in the catalogue by means of the corresponding color coordinates. Preferably, each page of the catalogue includes a two-dimensional extract of, e.g., a four-dimensional color space, in particular CMYK color space, with the color masters belonging to this extract. Such a two-dimensional extract is obtained, for example, by specifying two coordinates, the other two coordinates serving as parameters.

According to a preferred embodiment of the invention, for determination of the color coordinates of a sample a color measurement is first carried out with a color-measuring apparatus. By means of the color coordinates obtained in this way, the corresponding master with the same color coordinates is accessed in the color catalogue. The accuracy of the color catalogue preferably goes considerably beyond the accuracy of the color measurement, that is to say the number of discrete colors of the color catalogue is considerably higher than the number of colors between which the color-measuring apparatus can distinguish. The color coordinates obtained by the color measurement are therefore initially only provisional and are used as the starting point for fine matching with the colors of the color catalogue.

Various devices for color measurement and for the determination of color coordinates are indeed known from the prior art. However, these do not meet the accuracy requirements of exact determination or reproduction of the color of a sample for the purposes of a weathering test.

DE 196 44 616 A1 discloses a color-measuring device which has a light source and a photoelement for receiving the radiation reflected diffusely from the surface of the sample.

DE 196 44 617 A1 discloses a further method and a device for color measurement. This method is used to measure the color of a sample of granular or granulated goods in a container by recording the reflection of a measuring beam emitted from the measuring head of the color-measuring apparatus on to the surface of the sample.

U.S. Pat No. 5,526,285, JP-A 0 90 333 49, JP-A 0 72 982 8 1 and FR-A 27 08 105 disclose various further methods and devices for color determination. Color-measuring devices are commercially obtainable, e.g. from Dr. Bruno Lange GmbH, Königsweg 10, 14163 Berlin.

Such color-measuring devices which are already known have the disadvantage that the accuracy of the color measurement by far does not reach the accuracy with which an observer can distinguish various color shades from one another. This is to be attributed to the fact that the human eye can distinguish between a considerably higher number of different colors than the best available color-measuring devices.

The lack of accuracy of color-measuring devices and methods known from the prior art is solved according to the invention for the purposes of documenting the condition of a weathered sample in that a color catalogue which is used for fine matching of the color coordinates after a provisional determination of the color coordinates by means of a color-measuring apparatus is employed.

In a preferred embodiment of the invention, the user goes with the color coordinates obtained by the color measurement to the corresponding page of the catalogue which includes the color master with the color coordinates. The user then compares the sample with this color master and preferably also with further color masters on the same catalogue page which are adjacent to the first color master mentioned. This comparison preferably takes place under standardized conditions, that is to say under standardized light, preferably in accordance with ISO 3664.

In a further preferred embodiment of the invention, the color masters each have a hole in a central region. For an accurate color comparison, the user places the sample under the color master in question and thus has a direct comparison between the color of the sample surface and the color of the color master. On the basis of the visual comparison under standardized conditions with the color master of the color coordinates of the sample determined by measurement and the color masters adjacent thereto with color coordinates in a range surrounding the color coordinates recorded by measurement, the user then finally determines the color coordinates of the sample, which can deviate from the color coordinates determined by measurement because of the higher color resolution of the color catalogue compared with the color-measuring apparatus.

The determination of the provisional color coordinates by means of the color-measuring apparatus is particularly advantageous in as much as the user is given a starting point for undertaking the visual comparison of the color masters of the catalogue with the sample in this manner. Without such a starting point, the user would have to first find the best-matching catalogue page in an extremely extensive color catalogue, which can scarcely be carried out in practice. By measuring the color coordinates with a color-measuring device, the user can access the relevant catalogue page directly via the index of the catalogue, in order to carry out, starting from there, color comparisons with color masters of adjacent color coordinates on the same or adjacent catalogue pages.

In a further preferred embodiment of the invention, the color coordinates determined in this way are entered into a digital apparatus for the production of a color image, for example into a pictograph. An exact reproduction of the color of the surface of the sample can then be produced by means of the pictograph.

In a further preferred embodiment of the invention, the measurement of the color coordinates with the color-measuring device follows a three-dimensional color coordinate system. The color coordinates determined in the three-dimensional color coordinate system are then transformed into a four-dimensional color coordinate system. Appropriate methods for transforming color coordinates between various color coordinate systems are known to the skilled artisan, for example as disclosed in U.S. Pat. No. 6,108,442 and U.S. Pat. No. 6,137,596.

According to a further preferred embodiment of the invention, luminance image information of the sample is furthermore determined, for example by recording a black-and-white image of the sample or by means of a fine scanner which provides an LCH image signal. The L component, that is to say the luminance component, is then extracted from the LCH image signal and combined with the previously determined color coordinates in an image-processing program to give resulting image information. The C component of an LCH image signal indicates the chrominance, and the H component the color angle on a 360 degree color circle.

An image-processing program which may be used in the method and system of the present invention includes, for example, the program Adobe Photoshop, which generates a resulting overall image from a black-and-white image and additional color information in the form of color coordinates. This resulting image information can be used in turn to produce a digital color image by means of a pictograph.

It is of particular advantage here that, in addition to the color information, by recording the luminance information surface structures, textures and surface gloss can also be reproduced in the resulting image information or in the digital color image.

For example, accurate digital color images of weathered samples can be produced in this manner. Weathering tests are typically carried out by exposing various samples to weathering for various periods of time in order to determine the course of the weathering influence with respect to time. In the prior art, for this it is necessary to provide an independent sample for each weathering period.

On the other hand, the invention makes it possible to manage with only one sample for the entire weathering period, in that the sample is removed from the weathering device within given intervals of time, in order to produce a digital color image by the method according to the invention and then to return the sample to the weathering apparatus. The course of the weathering influence with respect to time can be recorded in this manner, without an extra sample or sample batch having to be provided for each interval of time.

Preferred embodiments of the invention are explained in more detail in the following with reference to the drawings. In the drawings:

FIG. 1 shows a preferred embodiment of a weathering system according to the invention. The weathering system has a weathering apparatus 100. The weathering apparatus 100 may be any desired weathering apparatus which is known to the skilled artisan, for example for weathering samples of plastics.

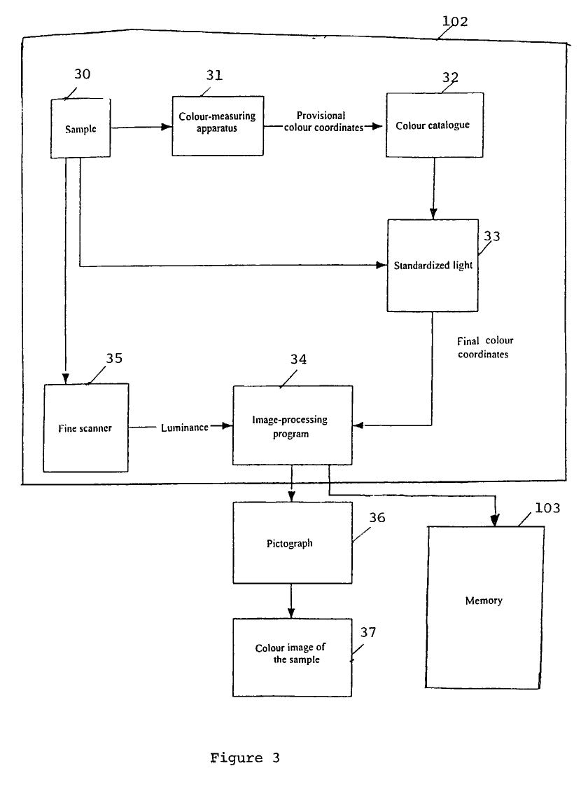

The weathering system furthermore includes a system 102 for determination of the color coordinates of a sample removed from the weathering apparatus 100. The system 102 can include, for example, a color-measuring apparatus. The system 102 moreover preferably includes a color catalogue system for fine matching of the color coordinates of the sample determined by means of the color-measuring apparatus. A corresponding embodiment is explained in more detail below with reference to FIG. 3.

A memory 103 is connected to the system 102. The color information determined by the system 102, that is to say, in particular, the color coordinates of the sample, is stored in the memory 103.

Alternatively or in addition, an imaging apparatus 104, which produces a color image of the sample on the basis of the image information supplied by the system 102, in particular on the basis of the color coordinates, is connected to the system 102. This color image can then be archived for documentation and evaluation purposes. The apparatus 104 is preferably a pictograph.

To operate the weathering system of FIG. 1, a sample 30 or a batch of samples 30 is first introduced into the weathering apparatus 100. After a particular interval of time the sample 30 is then removed from the weathering apparatus 100 in order to determine the color coordinates of the sample 30 at this point in time by means of the system 102. The color coordinates determined by means of the system 102 and optionally further image information are then stored in the memory 103 and/or used to produce a color image by means of the apparatus 104.

The sample 30 is then returned to the weathering apparatus 100, so that the weathering takes place over a further interval of time. After this interval of time has elapsed, the operation mentioned is repeated.

In this manner, complete documentation of the changes to the sample 30 caused by weathering is available at the end of the observation period of time for the weathering, namely on the color coordinates stored and/or the color images produced in each case after an interval of time. A weathering test of any desired duration of time can be carried out in this manner with only one sample 30 or one sample batch, which means a very substantial saving of expenditure compared with the prior art.

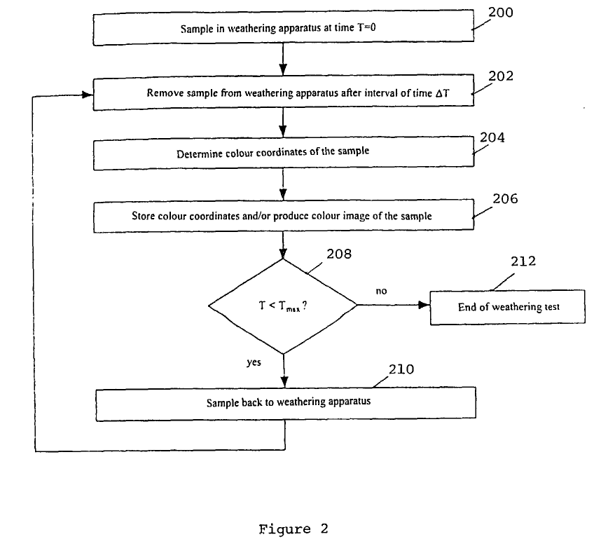

FIG. 2 shows a corresponding flow chart. In step 200 a sample or a sample batch is fed to a weathering apparatus at time T=0. In step 202 the sample or the sample batch is removed from the weathering apparatus, after weathering has taken place for an interval of time ΔT.

In step 204 the color coordinates of the sample or samples of the sample batch are then determined. Further surface information of the sample can be determined in addition, for example in respect of the texture and gloss of the sample surface.

In step 206 the color coordinates and optionally the further image information are stored. Alternatively or in addition, a color image of the sample is produced.

In step 208 it is determined whether the weathering period of time T so far, that is to say the total period of time so far during which weathering of the sample or of the sample batch has taken place, is shorter than a given period of time Tₘₐₓ. This period of time is equivalent to the total observation period of time for the influence of the weathering with respect to time on the sample or sample batch.

If the total observation period of time has not yet elapsed, the sample or the sample batch is returned to the weathering apparatus in step 210. Steps 202 to 210 are then repeated until testing in step 208 shows that the end of the total observation period of time is reached. In this case the weathering test is ended in step 212.

FIG. 3 shows a block diagram of a preferred embodiment of the system 102. A color-measuring apparatus 31 is used to determine the color coordinates of the sample 30. A color catalogue 32 which includes the discrete colors of a quantized color space is then accessed by means of the provisional color coordinates of the sample 30 determined by measurement, it being possible for the individual color masters to be accessed in the color catalogue 32 by means of the color coordinates thereof.

The color catalogue 32 can comprise, for example, various pages, each of which reproduces a two-dimensional extract of the multi-dimensional color space. The comparison of the color master selected in this way with the sample 30 under a standardized light apparatus 33 then follows. From this visual comparison with the color master or further color masters with adjacent color coordinates, the final color coordinates of the sample 30 then follow. These are entered into an image-processing program 34.

Luminance image information is furthermore generated by means of a fine scanner 35, and is likewise entered into the image-processing program 34. The image-processing program 34 combines the luminance image information with the color coordinates to give resulting image information, which is sent to a pictograph 36 to produce a color image 37 of the sample.

Alternatively or in addition, the output data from the image-processing program 34 is stored in a memory 103 for documentation purposes.

After the appearance of the sample 30 after an interval of time of weathering has been documented in this manner, the sample 30 is returned to the weathering apparatus (cf. weathering apparatus 100 of FIG. 1), so that weathering takes place during a further interval of time. Thereafter, the sample 30 is removed from the weathering apparatus again in order to document the condition of the sample after the further weathering.

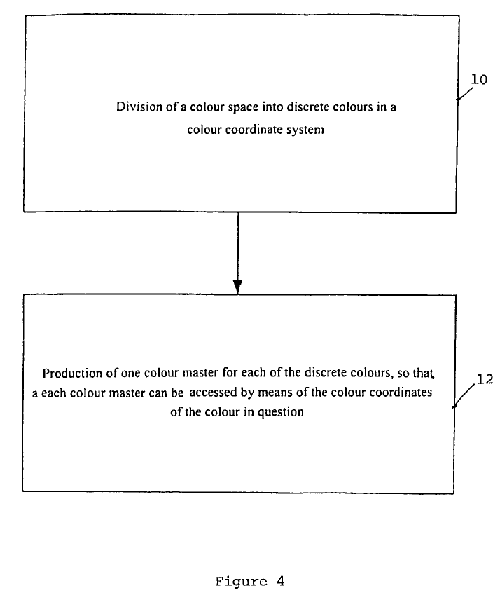

FIG. 4 shows a flow chart for the production of a color catalogue according to the invention. In step 10 a color space of interest is divided into discrete colors by means of a color coordinate system. Various known color coordinate systems are possible here, thus e.g. the RGB, CMY, LCH or CMYK system or another color coordinate system. Further color coordinate systems have been defined by the Commission Internationale L'Eclairage.

Unless otherwise noted below and without intending to limit the present invention, the CMYK system is used for the color coordinate system of the color masters and color catalogue.

In step 12 a color master is produced for each of the discrete colors of the color space divided up by the color coordinate system. The number of color masters here is given by the quantization intervals for discrete dividing of the color space. Each of the color masters is unambiguously identified by the color coordinates thereof in the color coordinate system chosen. The color coordinates of the color master serve as an index or as a code for access to the color master when the color coordinates are known.

Preferably, several such color masters are combined on one catalogue page, a catalogue page then reproducing a two-dimensional extract of the multi-dimensional color coordinate system.

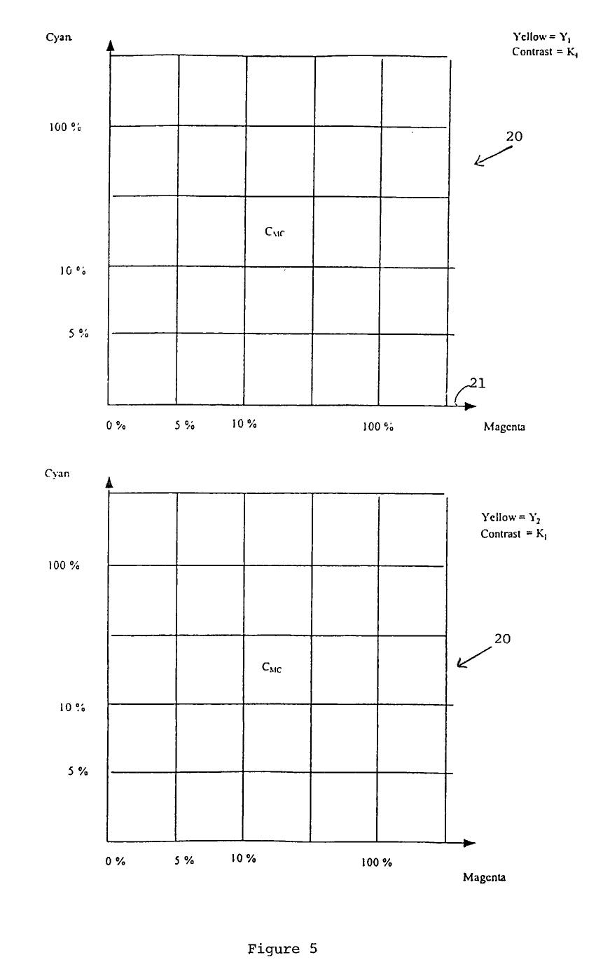

This is explained in more detail with reference to FIG. 5. FIG. 5 shows a page 20 of the color catalogue with a Cartesian coordinate system 21. The abscissa of the Cartesian coordinate system 21 indicates the M content, that is to say the magenta content, in percent and the ordinate of the Cartesian coordinate system 21 indicates the C content, that is to say the cyan content, also in percent. Page 20 represents an extract from the discrete color space, where in the corresponding section through the color space the cyan and magenta contents in each case vary between zero and a hundred percent and the Y, that is to say yellow, and the K, that is to say the contrast contents, are constant. In the example under consideration, the content Y has the value Y₁ and the content K has the value K₁ for all colors of this extract from the discrete color space.

In the embodiment example shown the color space has been quantized in five percent steps, it also being possible to choose smaller or larger steps, depending on the required accuracy.

Page 20 thus shows a matrix of color masters in which each of the color masters has the same Y component Y₁ and the same contrast component K₁ and only the magenta and cyan contents vary. Various color masters C_{MC} are thereby formed, each of which has a homogeneous discrete color with a particular percentage content of magenta and a particular percentage content of cyan and the contents Y₁ and K₁ which are constant for page 20. A particular color master can thus be accessed in the catalogue by means of the CMYK color coordinates thereof by choosing the catalogue page 20 with the yellow and contrast coordinates in question and then the color master on this catalogue page 20 with the appropriate magenta and cyan contents.

FIG. 5 shows a further page 20′ of the color catalogue which gives another extract from the discrete color space, namely for the yellow contents Y₂ and contrast contents K₁.

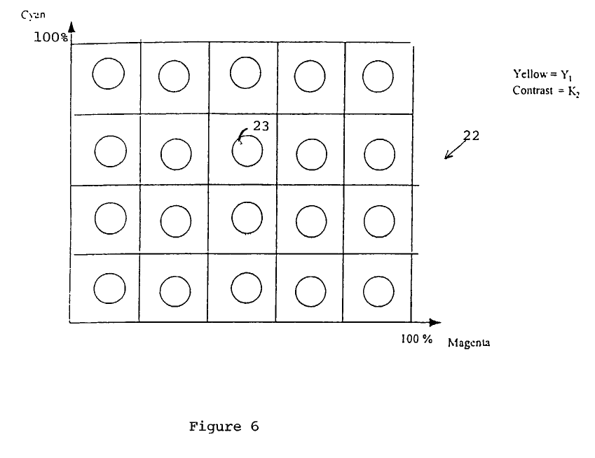

FIG. 6 shows a corresponding page 22 of such a color catalogue. In the embodiment of FIG. 3, each color master of page 22 has a hole 23 in a central region. A hole 23 is used for convenient comparison of the color of the color master with the color of a surface of the sample of which the exact color coordinates are to be determined. For such a visual comparison the sample is brought underneath the color master and viewed through the hole in the color master.

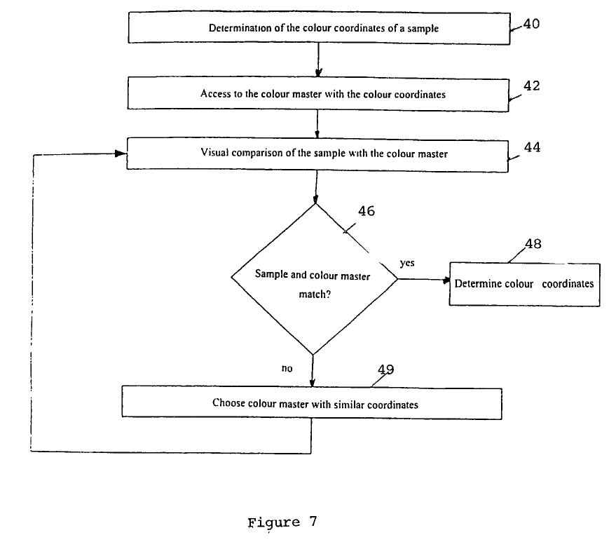

FIG. 7 shows a flow chart of a method for determination of the color coordinates.

In step 40 the color coordinates of the sample are first determined by measurement using a color-measuring device. In step 42 the corresponding color master is then accessed with these color coordinates. This is compared visually with the sample in step 44. This comparison is preferably carried out under standardized conditions, that is to say under standardized light.

In step 46 the user decides whether the sample matches the color master. If this is the case on the basis of the visual comparison, the color coordinates of the color master are at the same time the color coordinates of the sample and the color of the sample is thus determined.

If the opposite is the case, in step 49 another color master which has similar color coordinates is chosen by the user. This may be, for example, one or more color masters of the same page (cf. page 20 or page 22 of FIGS. 5 and 6 respectively) which are adjacent to the color master with the color coordinates determined by measurement. However, they can also be color masters of adjacent coordinates on different catalogue pages.

Such a color master chosen in step 49 is then in turn compared visually with the sample in step 44. The operation is repeated until the color master with the best color match with the sample has been found by the user.

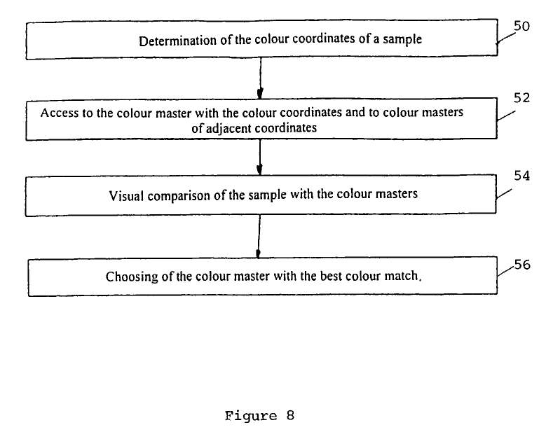

FIG. 8 shows an alternative embodiment of the method of FIG. 7, in which in step 50 the color coordinates of the sample are again first determined by measurement. In step 52 the color master in the color catalogue which has these color coordinates and further color masters with color coordinates adjacent thereto are then accessed. These are preferably color masters of the same catalogue page.

These color masters are compared visually with the sample in step 54, in order to determine the color master with the best color match (step 56).

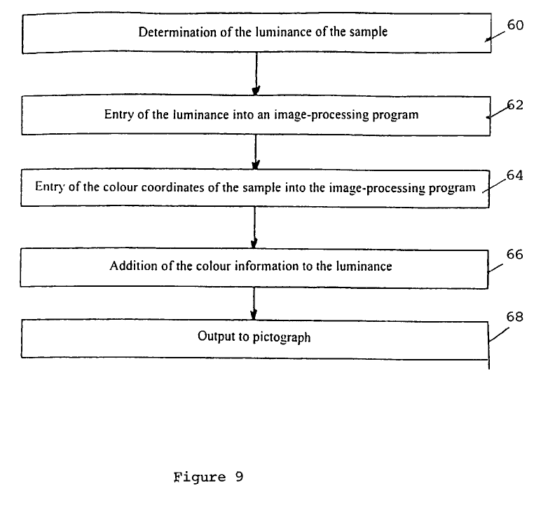

FIG. 9 illustrates a corresponding method for producing a digital color image. In step 60 a luminance of the sample is determined, preferably by means of a fine scanner which emits an LCH signal. The luminance in this case results from the L component of the signal emitted by the fine scanner.

This luminance information is entered into an image-processing program in step 62. A black-and-white image of the sample, which includes texture and/or gloss information, is obtained in this manner. In step 64 the previously determined color coordinates of the sample are also entered into the image-processing program, and in step 66 are combined with the luminance image information to give resulting image information. The image generated digitally in step 66 in this way is then sent in step 68 to an appropriate device which meets the accuracy requirements. A pictograph, for example, may be used for this purpose.

### LIST OF REFERENCE SYMBOLS

Step 10

Step 12

Page 20

Page 20′

Cartesian coordinate system 21

Page 22

Hole 23

Sample 30

Color-measuring apparatus 31

Color catalogue 32

Standardized light apparatus 33

Image-processing program 34

Fine scanner 35

Pictograph 36

Color image 37

Step 40

Step 42

Step 44

Step 46

Step 48

Step 49

Step 50

Step 52

Step 54

Step 56

Step 60

Step 62

Step 64

Step 66

Step 68

Weathering apparatus 100

System 102

Memory 103

Apparatus 104

Step 200

Step 202

Step 204

Step 206

Step 208

Step 210

Step 212

Although the invention has been described in detail in the foregoing for the purpose of illustration, it is to be understood that such detail is solely for that purpose and that variations can be made therein by those skilled in the art without departing from the spirit and scope of the invention except as it may be limited by the claims.

What is claimed is:

1. A method of weathering a sample over a period of time comprising:
(a) weathering the sample over a first interval of time;
(b) determining the color coordinates of the sample after the first interval of time; and
(c) repeating steps (a) and (b) for at least one successive interval of time until the completion of said period of time.

2. The method of claim 1 wherein step (b) comprises:
(i) measuring the color coordinates of the sample after the first interval of time;
(ii) providing access to at least one color master having color coordinates, said access being obtained by means of the color coordinates of said sample; and
(iii) comparing the color master with the sample for verification of the color coordinates.

3. The method of claim 1 wherein step (b) comprises:
(i) measuring the color coordinates of the sample after the first interval of time;
(ii) providing access to a color master having color coordinates and to at least one further color master having adjacent color coordinates, said access being obtained by means of the color coordinates of said sample; and
(iii) comparing the color master and the further color master with the sample, and determining which color master best matches the sample.

4. The method of claims 2 or 3 wherein comparison step (iii) is carried out visually.

5. The method of claim 4 wherein comparison step (iii) is carried out under standardized light.

6. The method of claim 2 wherein each color master has a hole in a central region, and a surface region of the sample is viewed through the hole for comparison with the color master.

7. The method of claim 2 wherein each color master is filed in a catalogue system and the catalogue system is indexed by means of the color coordinates of each color master, and each color master in the catalogue system is accessed by means of the color coordinates thereof.

8. The method of claim 7 wherein said catalogue system includes separate pages, and each page of said catalogue system includes a two-dimensional extract from a discrete color space.

9. The method of claim 7 wherein said catalogue system includes separate pages, and each page of said catalogue system includes a three-dimensional extract from a discrete color space.

10. The method of claim 7 wherein said catalogue system includes separate pages, and each page of said catalogue system includes a four-dimensional extract from a discrete color space.

11. The method of claim 2 wherein step (i) comprises measuring the three-dimensional color coordinates of the sample, and transforming the three-dimensional color coordinates into four-dimensional color coordinates, and in step (ii) access to said color master is obtained by means of the four-dimensional color coordinates of said sample.

12. The method of claim 1 further comprising:
entering the color coordinates of said sample into a means for producing a separate color image of the sample after each interval of time; and
producing separate color images for each interval of time.

13. The method of claim 12 further comprising:
determining luminance image information of the sample;
linking the luminance image information with the color coordinates to provide resulting image information; and
entering the resulting image information into said means for producing a color image.

14. The method of claim 13 wherein the luminance image information is obtained by recording a black-and-white image of the sample.

15. The method of claim 13 wherein the luminance image information is obtained by fine-scanning of the sample.

16. The method of claim 13 wherein the luminance image information is determined from the L component of an LCH signal.

17. The method of claim 12 wherein said means for producing said color image of said sample is a pictograph.

18. The method of claim 13 wherein at least one of the color coordinates, and the luminance image information and the resulting image information is stored after each interval of time.

19. A weathering system for weathering a sample over a period of time comprising:
(a) a means (100) for weathering the sample over a plurality of intervals of time of said period of time;
(b) a means (102) for determining the color coordinates of the sample, in each case after an interval of time; and
(c) at least one of,
(i) a means (103) for storing the color coordinates of the sample, determined by means (102), after each interval of time, and
(ii) a means (104) for producing a color image of the sample, from the color coordinates of the sample determined by means (102), after each interval of time.

20. The weathering system of claim 19 wherein the means for determining the color coordinates of the sample comprises,
a color catalogue of an n-dimensional color space,
said color catalogue comprising a color master for each of
the color coordinates of the n-dimensional color space, and
an index,
further wherein each of the color masters is accessible by means of the color coordinates of the sample.

21. The weathering system of claim 20 wherein each color master has a hole in a central region.

22. The weathering system of claim 20 wherein said color catalogue comprises separate pages and each catalogue page includes a two-dimensional extract of the n-dimensional color space.

23. The weathering system of claim 19 wherein the means for determining the color coordinates of the sample comprises,
a color-measuring apparatus (31) for determining provisional color coordinates of the sample, and
a color catalogue for verification of the provisional color coordinates, wherein the verification is obtained by comparing a corresponding color master of the color catalogue (32) with the sample.

24. The weathering system of claim 20 wherein the means for determining the color coordinates of the sample comprises a means (33) for providing standardized light for the comparison of the color master with the sample under standardized conditions.

25. The weathering system of claim 20 wherein the means for determining color coordinates of the sample is constructed for determination of three-dimensional color coordinates, and further comprises a means for transforming three-dimensional color coordinates into four-dimensional color coordinates of a four-dimensional color space of the color catalogue.

26. The weathering system of claim 19 further comprising,
a means (35) for determining luminance image information of the sample, and
a means (34) for linking the luminance image information with the color coordinates to give resulting image information,
wherein the means for producing the color image (c)(ii) is constructed for entry of the resulting image information.

27. The weathering system of claim 26 wherein the luminance image information is a black-and-white image.

28. The weathering system of claim 26 wherein the means for determination of the luminance image information is constructed as a fine scanner.

29. The weathering system of claim 28 wherein the fine scanner is constructed for generating an LCH color signal, and the luminance image information is optionally determined by omitting the C and H components of the LCH signal.

30. The weathering system of claim 19 wherein the means for producing the color image is constructed as a pictograph.
